(19) United States
(12) Patent Application Publication
(10) Pub. No.: US 2009/0154885 A1
(43) Pub. Date: Jun. 18, 2009

(54) OPTICAL TRANSMISSION CONNECTOR AND ELECTRONIC APPARATUS

(76) Inventor: Hiroshi MIZUNO, Tenri-shi (JP)

Correspondence Address: NIXON & VANDERHYE, PC, 901 NORTH GLEBE ROAD, 11TH FLOOR, ARLINGTON, VA, 22203, US

(21) Appl. No.: 12/259,393

(22) Filed: Oct. 28, 2008

(30) Foreign Application Priority Data
Dec. 12, 2007 (JP) 2007-321078

(51) Int. Cl. G02B 6/42

(52) U.S. Cl. 385/92

(57) ABSTRACT

An optical transmission connector according to an embodiment of the present invention includes: a holder portion including an element housing portion for housing a photoelectric effect element and a plug housing portion for housing an optical transmission plug; and a metal fixing leg that is formed of a metal plate and fixes the holder portion to a mounting substrate. The optical transmission connector includes an extension arm portion that extends from a side on which the metal fixing leg is disposed to a plug insertion base of the holder portion into which the optical transmission plug is inserted and has an extremity that is exposed at a plug insertion side surface of the plug insertion base. The metal fixing leg and the extension arm portion are formed of a single metal plate.

This application claims priority under 35 U.S.C. § 119(a) on Japanese Patent Application No. 2007-321078 filed in Japan on Dec. 12, 2007, the entire contents of which are herein incorporated by reference.

### BACKGROUND OF THE INVENTION

The present invention relates to an optical transmission connector including: a holder portion that includes an element housing portion for housing a photoelectric effect element and a plug housing portion for housing an optical transmission plug; and a metal fixing leg that is formed of a metal plate and fixes the holder portion to a mounting substrate, and an electronic apparatus in which such an optical transmission connector is employed.

Optical transmission connectors for transmitting electric signals in the form of optical signals have been proposed. Optical transmission connectors are implemented as optical fiber links that employ optical fibers, and are beginning to be used in electronic apparatuses that require a high noise resistance property, such as DVD players, DVD recorders, flat-screen TVs, STBs (set top boxes: an adapter apparatus for satellite broadcasting) and AV receivers, since they can form transmission systems that can reliably eliminate noise from the electric signals.

FIGS. 4(A) and 4(B) are diagrams illustrating an optical transmission connector according to Conventional Example 1. FIG. 4(A) is a front view with a plug housing portion into which an optical transmission plug is to be inserted being placed at the right. FIG. 4(B) is a side view as seen in the direction of arrow B of FIG. 4(A).

The optical transmission connector 101 according to Conventional Example 1 is of independent type that can be attached directly to a mounting substrate (not shown) of an electronic apparatus (not shown).

The optical transmission connector 101 that functions as a transmitter or receiver includes a holder portion 130 including an element housing portion 110 for housing a photoelectric effect element (not shown) and a plug housing portion 120 for housing an optical transmission plug 190 (see FIG. 6(A)) having an optical cable 193 (see FIG. 6(A)). The holder portion 130 includes a shutter portion 132 for preventing dust and extraneous matter from entering the optical transmission connector 101 (plug housing portion 120) and protecting the eyes from light leakage.

The optical transmission plug 190 is connected to the optical transmission connector 101 by inserting the optical transmission plug 190 (optical cable 193) and bringing it into contact with the shutter portion 132.

The optical transmission connector 101 includes a metal fixing leg 140 that is made of a metal as a means for fixing to a mounting substrate 186 (see FIG. 7). The metal fixing leg 140 is contacted and engaged with the surface of the holder portion 130, and is disposed such that it protrudes in the direction of the mounting substrate 186.

A lead terminal 111t of the photoelectric effect element 1 to be connected to the mounting substrate 186 is disposed such that it protrudes from the holder portion 130 parallel to the metal fixing leg 140 and in the direction of the mounting substrate 186.

FIGS. 5(A) and 5(B) are diagrams illustrating an optical transmission connector according to Conventional Example 2. FIG. 5(A) is a front view with a plug housing portion into which an optical transmission plug is to be inserted being placed at the right. FIG. 5(B) is a side view as seen in the direction of arrow B of FIG. 5(A).

The basic structure is the same as that of Conventional Example 1, and thus only differences will be described.

The optical transmission connector 101 according to Conventional Example 2 includes a fixing portion 135 having a screw opening 135h as a fixing means. That is, the optical transmission connector 101 according to Conventional Example 2 is of screw fixing type that is fixed to an instrument panel 185 (see FIG. 8(A)) of an electronic apparatus (not shown) by fixing the fixing portion 135 to the panel with a fixing screw 135f (see FIG. 8(A)).

An optical transmission plug 190 is connected to the optical transmission connector 101 by inserting the optical transmission plug 190 (optical cable 193) at a plug insertion hole 131w.

The fixation strength to the instrument panel 185 is secured by the fixing portion 135, and the fixation to a mounting substrate 186 (see FIG. 8(A)) is effected by a resin fixing leg 137 that is made of a resin, as is the holder portion 130.

FIGS. 6(A) to 6(C) are diagrams illustrating an optical transmission plug that is connected to the optical transmission connectors according to Conventional Examples 1 and 2. FIG. 6) is a plan view. FIG. 6(B) is a front view. FIG. 6(C) is a side view as seen in the direction of arrow C of FIG. 6(A).

The optical transmission plug 190 includes an optical fiber 194 serving as an optical transmission path in the center of an optical cable 193. A grip 192 is provided to an end of the optical cable 193 to secure operability and mechanical strength. Likewise, an optical transmission plug 190 is provided to the other end (not shown) of the optical cable 193.

The optical transmission connectors 101 according to Conventional Examples 1 and 2 and the optical transmission plug 190 shown in FIGS. 6) to 6(C) are of, what is called, a rectangular type that is defined by the former Electronic Industries Association of Japan (EIAJ), which was merged with the Japan Electronics and Information Technology Industries Association (JEITA). The former EIAJ defined the dimension of only a fitting portion for providing an interconnection. The dimensions of for example, the grip 192, the resin fixing leg 137, the metal fixing leg 140 and the holder portion 130 of the optical transmission connector 101 have not been defined, and thus they can be set freely.

FIG. 7 is a front view of the optical transmission connector according to Conventional Example 1 mounted on a mounting substrate.

An instrumental panel 185 constituting the casing of an electronic 6 apparatus and a mounting substrate 186 are attached to the optical transmission connector 101 of Conventional Example 1. The shutter portion 132 is exposed at the instrument panel 185 such that an optical transmission plug 190 can be inserted. The optical transmission connector 101 is fixed to the mounting substrate 186 by the soldered metal fixing leg 140, and the lead terminal 111t is connected to the mounting substrate 186 by soldering.

FIGS. 8(A) and 8(B) are diagrams illustrating the optical transmission connector of Conventional Example 2 mounted on a mounting substrate. FIG. 8(A) is a front view, and FIG. 8(B) is a cross section showing the internal configuration.

An instrumental panel 185 constituting the casing of an electronic apparatus and a mounting substrate 186 of the electronic apparatus are attached to the optical transmission connector 101 of Conventional Example 2. The shutter portion 132 is exposed at the instrument panel 185 such that an optical transmission plug 190 can be inserted. The optical transmission connector 101 is fixed to the instrument panel 185 with the fixing screw 135f, and the lead terminal 111t is connected to the mounting substrate 186 by soldering. The optical transmission connector 101 is fixed to the mounting substrate 186 by the resin fixing leg 137.

The end portion of the optical fiber 194 is positioned at a set point SP in compliance with the specifications such that the optical fiber 194 and the photoelectric effect element 111 do not come into direct contact with each other.

FIG. 9 is a side view conceptually showing a problem encountered in conventional technology when the optical transmission connector is mounted on an instrument panel and a mounting substrate.

Metals have previously been used for the instrument panel (attachment panel) 185, but recently resins having an insulating property are increasingly being used for the instrument panel 185 to respond to the requirements of cost reduction and weight reduction.

Furthermore, there is a case where an optical transmission connector 101 is placed separately in an opening 185w of an instrument panel 185 without contact with the instrument panel 185 as shown in FIG. 9 when attaching the optical transmission connector 101 to the instrument panel 185 (see FIGS. 7 and 8(A)).

In a state as shown in FIG. 9 in which the optical transmission connector 101 is provided without contact with the instrument panel 185, static electricity (ESD) may occur when the optical transmission plug 190 is connected to the optical transmission connector 101 or when a component (e.g., another connector) other than the optical transmission connector 101 is mounted on the mounting substrate 186.

When static electricity (ESD) exists in the surroundings, since no metal portion is provided around the opening 185w and the exposed face (plug insertion base 131) of the optical transmission connector 101, a problem arises in that the static electricity (ESD) enters the inside of the optical transmission connector 101 through the opening (not shown) of the shutter portion 132 (Conventional Example 1, see FIGS. 4(A) and 4(B)) that is connected to a spring portion for operating the shutter mechanism, the opening (not shown) into which the optical transmission plug 190 is inserted after the shutter portion 132 is opened, the plug insertion hole 131w (Conventional Example 2, see FIGS. 6(A) and 5(B)) or the like, which may cause damage to the photoelectric effect element 111.

An optical transmission connector in which a noise removal technique is applied has been proposed in, for example, JP 2000-75171A, and an electric connector in which a shielding technique is applied has been proposed in, for example, JP H4-87184U. In addition, the present applicant has made a proposal in JP 2007-65366A.

### SUMMARY OF THE INVENTION

The present invention has been conceived in light of the above circumstances, and it is an object of the present invention to provide a highly reliable optical transmission connector including a holder portion including an element housing portion for housing a photoelectric effect element and a plug housing portion for housing an optical transmission plug; and a metal fixing leg that is formed of a metal plate and fixes the holder portion to a mounting substrate, wherein it is possible to reliably block static electricity from entering the inside of the holder portion from the plug insertion side surface and to protect the photoelectric effect element from damage by providing an extension arm portion that extends from a side on which the metal fixing leg is disposed to a plug insertion base of the holder portion into which the optical transmission plug is inserted and has an extremity that is exposed at a plug insertion side surface of the plug insertion base.

It is another object of the present invention to provide a highly reliable electronic apparatus that includes an optical transmission connector, has a resistance against electrostatic damage and allows easy handling of the optical transmission connector by using the optical transmission connector according to the present invention as the optical transmission connector.

The optical transmission connector according to the present invention is an optical transmission connector including: a holder portion including an element housing portion for housing a photoelectric effect element and a plug housing portion for housing an optical transmission plug; and a metal fixing leg that is formed of a metal plate and fixes the holder portion to a mounting substrate, wherein the optical transmission connector comprises an extension arm portion that extends from a side on which the metal fixing leg is disposed to a plug insertion base of the holder portion into which the optical transmission plug is inserted and has an extremity that is exposed at a plug insertion side surface of the plug insertion base, and the metal fixing leg and the extension arm portion are formed with a single metal plate.

This configuration can reliably block static electricity from entering the inside of the holder portion from the plug insertion side surface, making it possible to provide a highly reliable optical transmission connector that can protect the photoelectric effect element from damage.

In the optical transmission connector of the present invention, the plug insertion base includes a through hole through which the extremity is exposed at the plug insertion side surface.

With this configuration, the extension arm portion can be positioned with high accuracy while the effect of blocking static electricity is maintained.

In the optical transmission connector of the present invention, a plurality of extension arm portions are disposed, and a plurality of through holes are formed to correspond to the extension arm portions.

With this configuration, it is possible to reliably position and dispose a plurality of extension arm portions and increase the area over which static electricity is blocked.

In the optical transmission connector of the present invention, the plug insertion base has a rectangular shape as seen from the plug insertion side, and the plurality of through holes are disposed on a crossline diagonally crossing the rectangular shape.

With this configuration, the effect of blocking static electricity can be obtained over a large area.

In the optical transmission connector of the present invention, the extremity inserted into the through hole has a width smaller than a width of the extension arm portion.

With this configuration, the positioning operation of the extension arm portion can be facilitated and carried out with high accuracy.

In the optical transmission connector of the present invention, a connecting portion that connects the metal fixing leg and the extension arm portion with a single metal plate is provided.

With this configuration, the mutual position of the metal fixing leg and the extension arm portion can be adjusted easily, and thus the metal fixing leg and the extension arm portion can be positioned at optimal positions.

In the optical transmission connector of the present invention, the connecting portion is engaged with a step portion formed in the holder portion, and is fixed by a protrusion formed in the holder portion opposite to the step portion so that the extremity is positioned.

With this configuration, the connecting portion is positioned and fixed by the step portion and the protrusion, and it is thus possible to position the extension arm portion with high accuracy.

In the optical transmission connector of the present invention, the metal fixing leg is disposed to face both of two opposing faces of the holder portion, and the connecting portion is configured to extend to connect the two metal fixing legs.

With this configuration, the metal fixing legs are disposed in both faces of the holder portion, the fixation strength of the holder portion to a mounting substrate by the metal fixing legs and the connecting strength of the metal fixing legs to the holder portion can be improved, and the holder portion (optical transmission connector) can be reliably fixed to the mounting substrate.

In the optical transmission connector of the present invention, the connecting portion has an L-shaped metal plate corner portion engaged with the step portion, the step portion has a step corner portion corresponding to the metal plate corner portion, and the step corner portion is rounded.

With this configuration, the engagement of the connecting portion with the holder portion can be facilitated, and thus the positioning of the extension arm portion (extremity) can be carried out with ease and high accuracy.

In the optical transmission connector of the present invention, the step corner portion has a notch in addition to the rounded portion.

With this configuration, the positioning of the extension arm portion (extremity) can be carried out with more ease and higher accuracy.

In the optical transmission connector of the present invention, a frame-like metal plate disposed on the plug insertion side surface of the plug insertion base is provided, and the frame-like metal plate is connected to the extension arm portion.

With this configuration, static electricity entering from the plug insertion side surface can be blocked completely regardless of the position at which the static electricity enters, and it is therefore possible to provide a highly reliable optical transmission connector that can block static electricity with high accuracy.

An electronic apparatus according to the present invention is an electronic apparatus that includes an optical transmission connector, wherein the optical transmission connector is the optical transmission connector of the present invention.

With this configuration, it is possible to provide a highly reliable electronic apparatus that has a large resistance against electrostatic damage and allows easy handling of the optical transmission connector. As described above, with the optical transmission connector of the present invention, it is possible to reliably block static electricity from entering the inside of the holder portion from the plug insertion side surface and to produce the effect of providing a highly reliable optical transmission connector that can protect the photoelectric effect element from damage.

Furthermore, with the electronic apparatus of the present invention, because the optical transmission connector of the present invention is included, it is possible to produce the effect of providing a highly reliable electronic apparatus that has a large resistance against electrostatic damage and allows easy handling of the optical transmission connector.

### BRIEF DESCRIPTION OF THE DRAWINGS

FIGS. 1(A) to 1(C) are diagrams illustrating a schematic configuration of an optical transmission connector according to Embodiment 1 of the present invention. FIG. 1(A) is a front view with a plug housing portion into which an optical transmission plug is to be inserted being placed at the right. FIG. 1(B) is a side view as seen in the direction of arrow B of FIG. 1(A). FIG. 1(C) is a bottom view as seen in the direction of arrow C.

FIG. 2 is an enlarged front view illustrating details of the optical transmission connector of FIG. 1(A).

FIG. 3 is a diagram illustrating a schematic configuration of an optical transmission connector according to Embodiment 2 of the present invention, and is a side view at a position corresponding to FIG. 1(B).

FIGS. 4(A) and 4(B) are diagrams illustrating an optical transmission connector according to Conventional Example 1. FIG. 4(A) is a front view with a plug housing portion into which an optical transmission plug is to be inserted being placed at the right. FIG. 4(B) is a side view as seen in the direction of arrow B of FIG. 4(A).

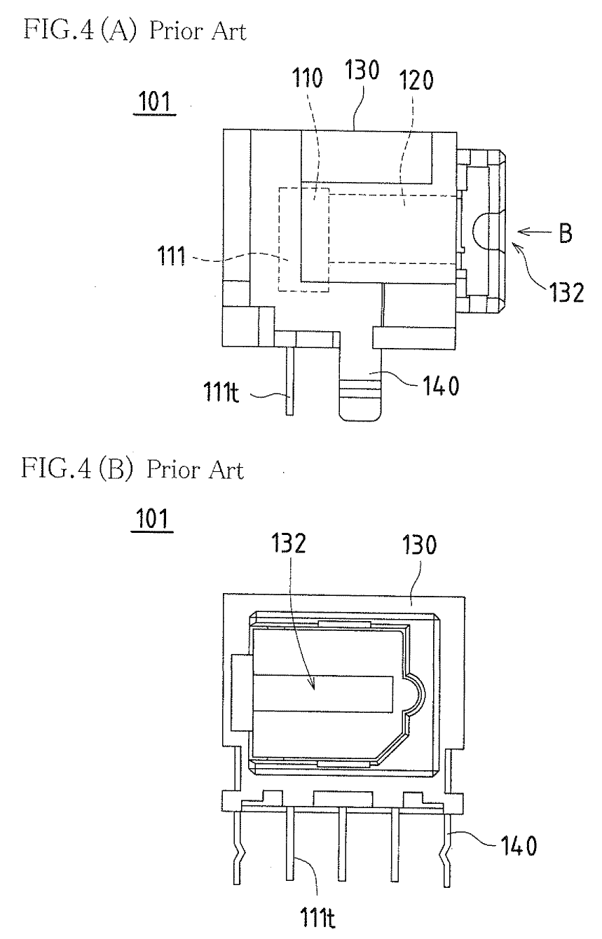

FIGS. 5(A) and 5(B) are diagrams illustrating an optical transmission connector according to Conventional Example 2. FIG. 5(A) is a front view with a plug housing portion into which an optical transmission plug is to be inserted being placed at the right. FIG. 5(B) is a side view as seen in the direction of arrow B of FIG. 5(A).

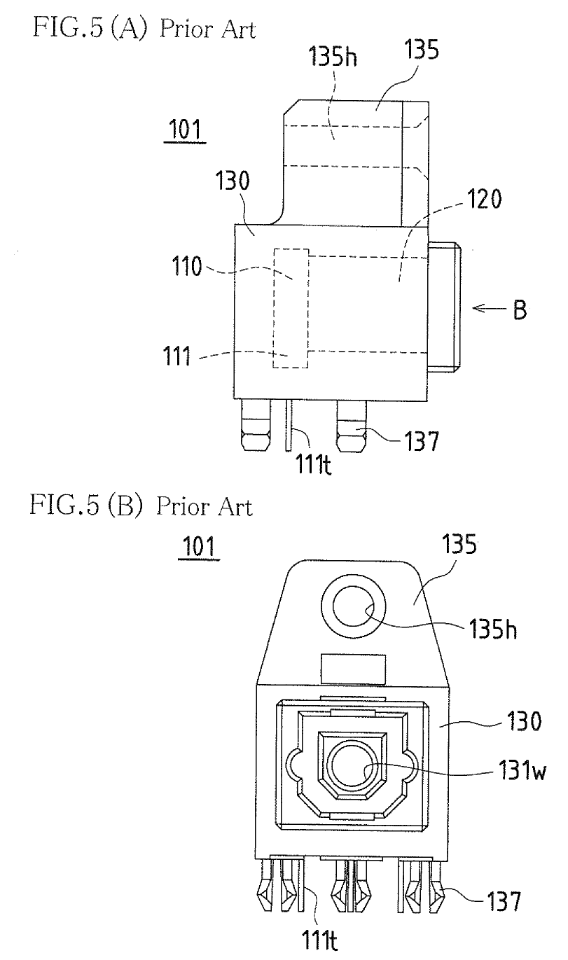

FIGS. 6(A) to 6(C) are diagrams illustrating an optical transmission plug that is connected to the optical transmission connectors according to Conventional Examples 1 and 2. FIG. 6(A) is a plan view. FIG. 6(B) is a front view. FIG. 6(C) is a side view as seen in the direction of arrow C of FIG. 6(A).

FIG. 7 is a front view illustrating the optical transmission connector according to Conventional Example 1 mounted on a mounting substrate.

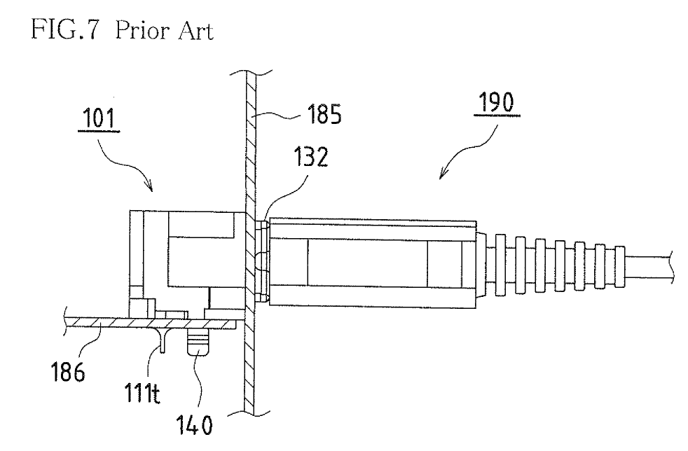

FIGS. 8(A) and 8(B) are diagrams illustrating the optical transmission connector according to Conventional Example 2 mounted on a mounting substrate. FIG. 8(A) is a front view. FIG. 8(B) is a cross section showing its internal configuration.

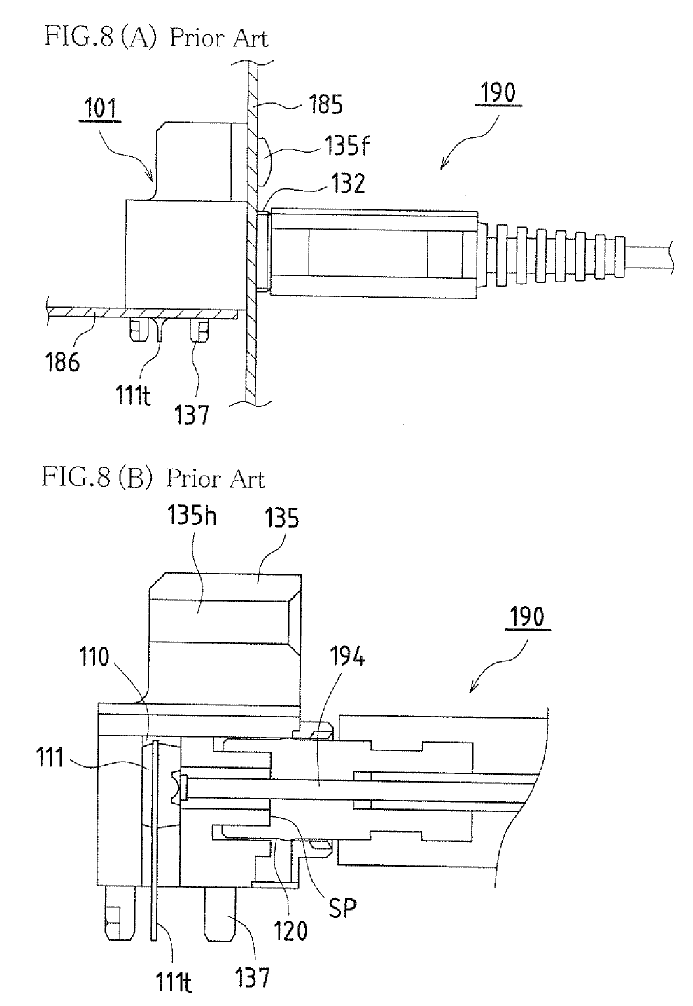

FIG. 9 is a side view conceptually showing a problem encountered in conventional technology when an optical transmission connector is mounted on an instrument panel and a mounting substrate.

### DESCRIPTION OF THE PREFERRED EMBODIMENTS

Hereinafter, preferred embodiments of the present invention will be described with reference to the accompanying drawings.

### Embodiment 1

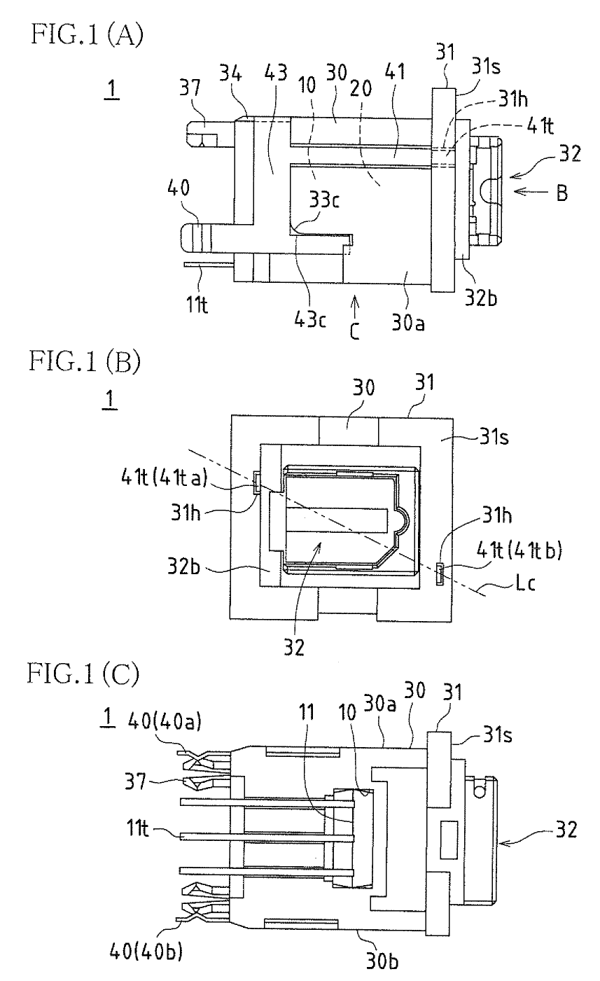

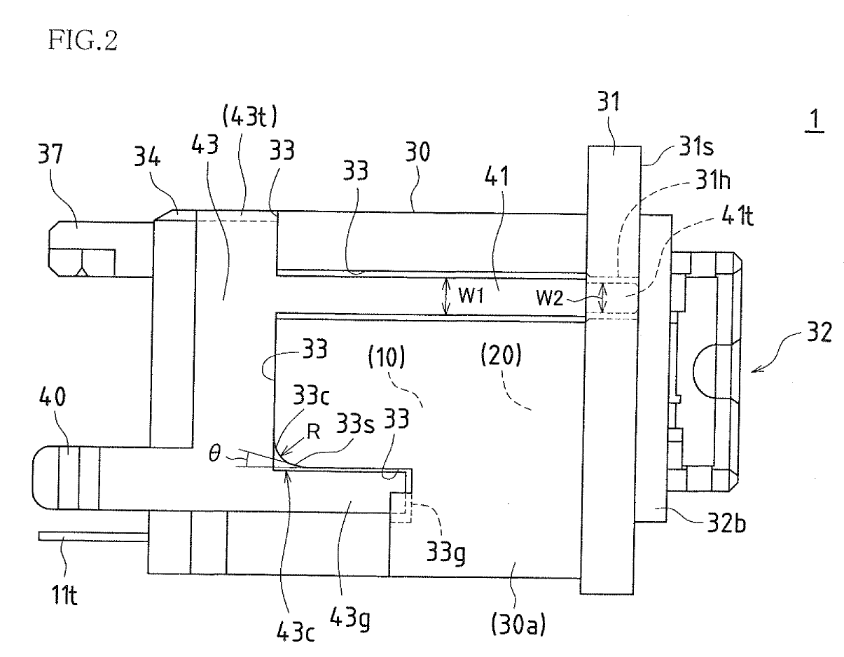

An optical transmission connector according to Embodiment 1 will be described with reference to FIGS. 1 and 2.

FIGS. 1(A) to 1(C) are diagrams illustrating a schematic configuration of an optical transmission connector according to Embodiment 1 of the present invention. FIG. 1(A) is a front view with a plug housing portion into which an optical transmission plug is to be inserted being placed at the right. FIG. 1(B) is a side view as seen in the direction of arrow B of FIG. 1(A). FIG. 1(C) is a bottom view as seen in the direction of arrow C.

FIG. 2 is an enlarged front view illustrating details of the optical transmission connector of FIG. 1A).

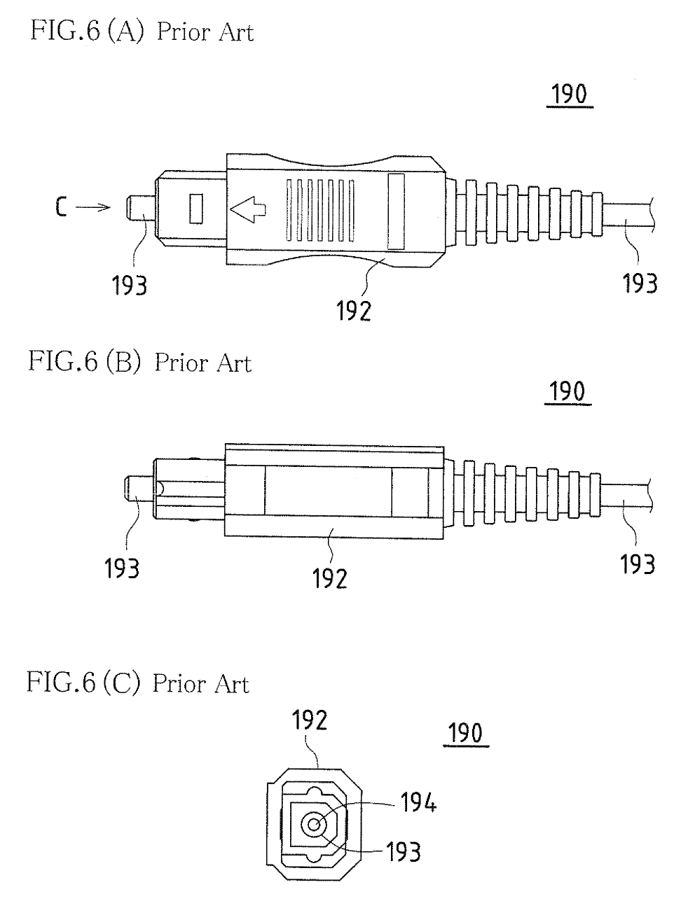

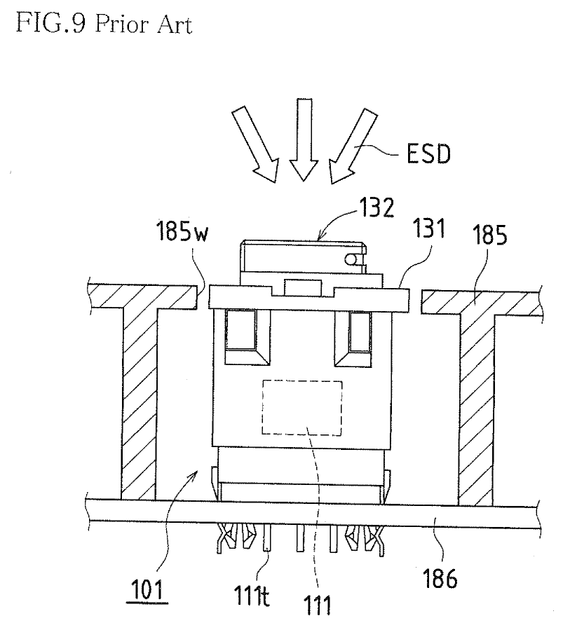

The optical transmission connector 1 according to the present embodiment includes: a holder portion 30 constituting an element housing portion 10 for housing a photoelectric effect element 11 and a plug housing portion 20 for housing an optical transmission plug 190 (see FIG. 6(A), etc. the optical transmission plug 190 may be a conventional one); and a metal fixing leg 40 that is formed of a metal plate and fixes the holder portion 30 to a mounting substrate 186 (see FIG. 9, the mounting substrate 186 may be a conventional one).

The photoelectric effect element 11 may be either a light-emitting element or light-receiving element, or an element that includes both. When a light-emitting element is incorporated, it functions as a transmitter. When a light-receiving element is incorporated, it functions as a receiver. When both a light-emitting element and a light-receiving element are incorporated, it functions as transmitter and receiver.

The optical transmission connector 1 further includes an extension arm portion 41 that extends from the side on which the metal fixing leg 40 is disposed to a plug insertion base 31 of the holder portion 30 into which an optical transmission plug 190 is to be inserted, and has an extremity 41t exposed at a plug insertion side surface 31s of the plug insertion base 31. The metal fixing leg 40 and the extension arm portion 41 are formed of a single metal plate.

Because the static electricity entering the optical transmission connector 1 from the direction of insertion of the optical transmission plug 190 is discharged to the metal fixing leg 40 through the extension arm portion 41, it is possible to ensure that the static electricity is blocked from entering the inside (element housing portion 10, plug housing portion 20) of the holder portion 30 from the plug insertion side surface 31s, and to make the optical transmission connector 1 highly reliable and capable of protecting the photoelectric effect element 11 from damage.

The optical transmission connector 1 according to the present embodiment further includes a shutter portion 32 that can be opened by insertion of the optical transmission plug 190. The shutter portion 32 is joined to the plug insertion base 31 with a shutter base 32b interposed therebetween (typically, the plug insertion base 31 and the shutter base 32b can be formed as a single unit). The optical transmission plug 190 is configured to be inserted into the shutter portion 32 from the right direction (the direction of arrow B) of FIG. 1(A) by pushing and connecting it to the optical transmission connector 1.

The provision of the shutter portion 32 can prevent dust and extraneous matter from entering the plug housing portion 20 for housing an optical transmission plug 190, and suppress the influence of light leakage on the human body (eyes).

The plug insertion base 31 includes a through hole 31h through which the extremity 41t is exposed at the plug insertion side surface 31s. This enables highly accurate positioning of the extension arm portion 41 while the effect of blocking static electricity is maintained.

Because a plurality of extension arm portions 41 are disposed and a plurality of through holes 31h are formed to correspond to the extension arm portions 41, it is possible to position and dispose the plurality of extension arm portions 41 with high accuracy and reliability, and increase the area over which static electricity is blocked.

The plug insertion base 31 has a rectangular shape as seen from the plug insertion side (the direction of arrow B in FIG. 1(A)), and the plurality of through holes 31h are disposed on a crossline Lc diagonally crossing the rectangular shape (see FIG. 1(B)). Accordingly, the effect of blocking static electricity can be attained not only when static electricity enters from the front, but also when static electricity enters from any of the upper. lower, right and left directions of FIG. 1(B), and therefore the effect of blocking static electricity can be obtained over a large area.

In the present embodiment, as an example, two extension arm portions 41 are disposed, and an extremity 41t is exposed at each of two through holes 31h. As shown in FIG. 1(B), two extremities 41t (extremity 41ta and extremity 41tb) are disposed asymmetrically to each other as described above.

The width W2 of the extremity 41t inserted into the through hole 31h is made smaller than the width W1 of the extension arm portion 41. Specifically, the width W2 of the extremity 41t is made approximately 10 to 20 percent smaller than the width W1 of the extension arm portion 41. Accordingly, the positioning operation of the extension arm portion 41 with respect to the through hole 31h can be facilitated and carried out with high accuracy.

The optical transmission connector 1 further includes a connecting portion 43 that connects the metal fixing leg 40 and the extension arm portion 41 with a single metal plate. With this, the mutual position of the metal fixing leg 40 and the extension arm portion 41 can be adjusted easily, and thus the metal fixing leg 40 and the extension arm portion 41 can be positioned at optimal positions.

The connecting portion 43 is engaged with a step portion 33 formed in the holder portion 30, and is fixed by a protrusion 34 formed in the holder portion 30 opposite to the step portion 33 so that the extremity 41t can be positioned. Because the connecting portion 43 (connecting portion 43t) can be positioned and fixed by the step portion 33 and the protrusion portion 34, the extension arm portion 41 can be positioned with high accuracy.

The metal fixing legs 40 (metal fixing legs 40a and 40b, see FIG. 1(C)) are disposed to respectively face two opposing faces (holder portion side faces 30a and 30b) of the holder portion 30. The connecting portion 43 is configured to extend to connect the two metal fixing legs 40.

Because the metal fixing legs 40 are disposed on both faces (holder portion side faces 30a and 30b, see FIG. 1(C)) of the holder portion 30, the fixation strength of the holder portion 30 to a mounting substrate 186 by the metal fixing legs 40 and the connecting strength of the metal fixing legs 40 to the holder portion 30 can be improved, and the holder portion 30 (optical transmission connector 1) can be reliably fixed to the mounting substrate 186. The metal fixing legs 40a and 40b are connected to the connecting portion 43 corresponding to the extremities 41ta and 41tb, and the connecting portions 43 of both faces (holder portion side faces 30a and 30b) of the holder portion 30 further extend so as to be connected by the connecting portion 43t.

That is, the connecting portion 43 is configured such that the connecting portions 43 of both faces (holder portion side faces 30a and 30b) of the holder portion 30 and the connecting portion 43t form a U shape to surround the holder portion 30 (with three faces), further improving the connecting strength to the holder portion 30.

The connecting portion 43 has an L-shaped metal plate corner portion 43c engaged with the step portion 33. The step portion 33 has a step corner portion 33c corresponding to the metal plate corner portion 43c. The step corner portion 33c is rounded (R) (see FIG. 2). This facilitates the engagement of the connecting portion 43 with the holder portion 30 (the insertion of the extremity 41t into the through hole 31h), and thus the positioning of the extension arm portion 41 (extremity 41t) can be carried out with ease and high accuracy.

The step corner portion 33c has a notch 33s in addition to the rounded portion R. Accordingly, the positioning of the extension arm portion 41 (extremity 41t) can be carried out with more ease and higher accuracy. The notch 33s is configured to have a notch angle θ with respect to a straight portion (e.g., a straight portion that is formed parallel to the straight portion of the extension arm portion 41) of the step portion 33.

A portion (connecting portion 43g) of the connecting portion 43 constituting the metal plate corner portion 43c extends parallel to the extension arm portion 41, and is fitted to a hidden groove 33g formed in the holder portion 30 so as to further improve the connecting strength between the connecting portion 43 and the holder portion 30.

In the holder portion side face 30a, the connecting portion 43 (connecting portion 43g) is disposed parallel to the extension arm portion 41, whereas in the holder portion side face 30b, an extension arm portion 41 (extremity 41tb) is disposed in the position corresponding to the connecting portion 43g (see FIG. 1(B)).

As the metal plate for constituting the metal fixing legs 40, the extension arm portions 41 and the connecting portions 43, for example, aluminum, copper and so on can be used. The thickness can be, for example, about 0.1 mm to 0.3 mm taking the processability and strength into account.

The optical transmission connector 1 of the present embodiment was subjected to the following electrostatic discharge test in compliance with the IEC 61000-4-2 standard (electrostatic immunity test), which is an international standard.

When the distance between a discharge electrode of a discharge tester (potentials of +20 kV and −20 kV were applied separately to cause a spark) and the end (the surface of the shutter portion 32) of the optical transmission connector 1 was set to 15 mm, no electrostatic damage occurred in each of the five samples for the conventional optical transmission connector and the optical transmission connector 1 of the present embodiment.

When the distance between a discharge electrode of a discharge tester (potentials of +20 kV and −20 kV were applied separately to cause a spark) and the end (the surface of the shutter portion 32) of the optical transmission connector 1 was set to 0 mm (critical test), after application was repeated 10 times, two out of the five samples for the conventional optical transmission connector suffered damage, whereas no electrostatic damage occurred in the five samples for the optical transmission connector 1 of the present embodiment. Even after application was repeated 30 times, no electrostatic damage occurred in the samples for the optical transmission connector 1 of the present embodiment.

As described above, according to the optical transmission connector 1 of the present embodiment, by simply employing a simple structure in which the extremity 41t of the extension arm portion 41 is exposed at the plug insertion base 31 (plug insertion side surface 31s), it was possible to obtain an extremely large resistance against damage.

### Embodiment 2

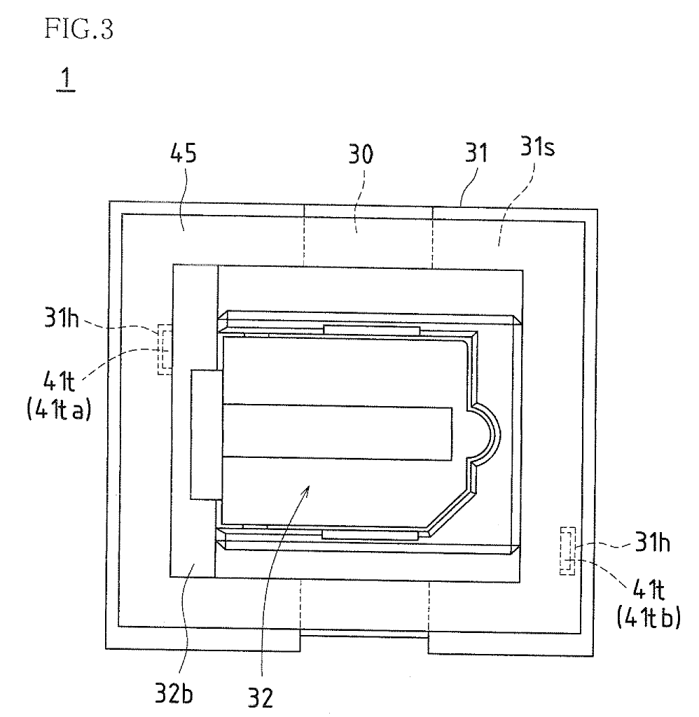

An optical transmission connector according to Embodiment 2 will be described with reference to FIG. 3.

FIG. 3 is a diagram illustrating a schematic configuration of the optical transmission connector according to Embodiment 2 of the present invention, and is a side view at a position corresponding to FIG. 1(B).

The optical transmission connector 1 according to the present embodiment has a basic structure similar to that of Embodiment 1, and thus only a difference from Embodiment 1 will be described.

The optical transmission connector 1 according to the present embodiment includes a frame-like metal plate 45 disposed on the plug insertion side surface 31s of the plug insertion base 31. The frame-like metal plate 45 is connected to the extension arm portion 41 (extremity 41t). With this, static electricity entering from the plug insertion side surface 31s can be blocked completely regardless of the position at which the static electricity enters, and it is therefore possible to make the optical transmission connector 1 even more highly reliable and capable of blocking static electricity with high accuracy.

The frame-like metal plate 45 and the extension arm portion 41 (extremity 41t) can be connected by, for example, adhesion with a conductive adhesive or solder, or they may be contact-connected using the spring properties of the frame-like metal plate 45 and the extension arm portion 41.

### Embodiment 3

An electronic apparatus (not shown) according to Embodiment 3 is an electronic apparatus in which an optical transmission connector is mounted, and the optical transmission connector 1 described in Embodiment 1 or 2 is used as the optical transmission connector. With this, it is possible to provide a highly reliable electronic apparatus that has a large resistance against electrostatic damage and allows easy handling of the optical transmission connector.

Examples of the electronic apparatus according to the present embodiment include DVD players, DVD recorders, flat-screen TVs, STBs (set top boxes: an adapter apparatus for satellite broadcasting), AV receivers, etc.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. An optical transmission connector comprising:
a holder portion including an element housing portion for housing a photoelectric effect element and a plug housing portion for housing an optical transmission plug; and
a metal fixing leg that is formed of a metal plate and fixes the holder portion to a mounting substrate,
wherein the optical transmission connector comprises an extension arm portion that extends from a side on which the metal fixing leg is disposed to a plug insertion base of the holder portion into which the optical transmission plug is inserted and has an extremity that is exposed at a plug insertion side surface of the plug insertion base, and
the metal fixing leg and the extension arm portion are formed with a single metal plate.

2. The optical transmission connector according to claim 1,
wherein the plug insertion base includes a through hole through which the extremity is exposed at the plug insertion side surface.

3. The optical transmission connector according to claim 1,
wherein a plurality of extension arm portions are disposed, and a plurality of through holes are formed to correspond to the extension arm portions.

4. The optical transmission connector according to claim 1,
wherein the plug insertion base has a rectangular shape as seen from the plug insertion side, and the plurality of through holes are disposed on a crossline diagonally crossing the rectangular shape.

5. The optical transmission connector according to claim 1
wherein the extremity inserted into the through hole has a width smaller than a width of the extension arm portion.

6. The optical transmission connector according to claim 1, further comprising a connecting portion that connects the metal fixing leg and the extension arm portion with a single metal plate.

7. The optical transmission connector according to claim 6,
wherein the connecting portion is engaged with a step portion formed in the holder portion, and is fixed by a protrusion formed in the holder portion opposite to the step portion so that the extremity is positioned.

8. The optical transmission connector according to claim 6,
wherein the metal fixing leg is disposed to face both of two opposing faces of the holder portion, and the connecting portion is configured to extend to connect the two metal fixing legs.

9. The optical transmission connector according to claim 6,
wherein the connecting portion has an L-shaped metal plate corner portion engaged with the step portion, the step portion has a step corner portion corresponding to the metal plate corner portion, and the step corner portion is rounded.

10. The optical transmission connector according to claim 9,
wherein the step corner portion has a notch in addition to the rounded portion.

11. The optical transmission connector according to claim 1, comprising a frame-like metal plate disposed on the plug insertion side surface of the plug insertion base,
wherein the frame-like metal plate is connected to the extension arm portion.

12. An electronic apparatus in which an optical transmission connector is mounted, wherein the optical transmission connector is the optical transmission connector according to claim 1.
